(19) United States
(12) Patent Application Publication
(10) Pub. No.: US 2026/0341611 A1
(43) Pub. Date: Oct. 29, 2026

(54) Fast-Acting Bistable Relay and Motor Vehicle Therewith

(71) Applicant: Bayerische Motoren Werke Aktiengesellschaft, Muenchen (DE)

(72) Inventor: Andreos Tryphonos, Ilmmuenster (DE)

(21) Appl. No.: 19/654,661

(22) Filed: Apr. 22, 2026

(30) Foreign Application Priority Data
Apr. 23, 2025 (DE) 10 2025 115 559.3

(51) Int. Cl. H01H 21/22; B60L 1/00; B60L 3/04; H01H 3/26

(52) U.S. Cl. CPC H01H 21/22; B60L 1/00; B60L 3/04; H01H 3/26

(57) ABSTRACT

A bistable relay includes a rotatable lever element and a guide element mounted rotatably about a shaft. The guide element has a guide groove in which a projection of the lever element is guided. The relay also has a spring which is connected to the shaft and one end of the lever element. When the guide element rotates, the projection can in each case be pulled suddenly into different positions by the spring loading of the lever element. As a result, an actuating element connected to another end of the lever element can be moved into a closed position or into an open position in order to make or break an electrical connection. A motor vehicle having such a bistable relay is also provided.

### CROSS REFERENCE TO RELATED APPLICATION

This application claims priority under 35 U.S.C. §119 from German Patent Application No. 10 2025 115 559.3, filed Apr. 23, 2025, the entire disclosure of which is herein expressly incorporated by reference.

### BACKGROUND AND SUMMARY

The present invention relates to a bistable relay for switchably making and breaking an electrical connection. The invention relates also to a motor vehicle having such a bistable relay.

In many different technical applications, it must be possible for electrical connections to be made and interrupted switchably and controllably. Various types of relays can be used for this purpose. Conventional monostable relays typically require during operation a permanent supply of energy or voltage for maintaining a specific switching state. In many applications, such as for example also in automotive engineering, however, the overall energy requirement needs to be reduced. To do this, bistable relays can be used which require energy only to change the switching state. There are, however, also challenges with such bistable relays. It is thus possible, for example, for considerable wear to occur at the relays because of arcs or sparks during switching processes. Likewise, for example, as high as possible a switching speed and/or a certain minimum force between electrical contacts need to be achieved, too great a manufacturing effort and too high an expenditure need to be avoided and/or a certain safety level, for example, in terms of touch safety, operational safety or functional safety need to be achieved. Against this background, there are already a large number of different approaches to solving the problem.

For example, DE 10 2017 122 008 B4 describes an electrical switch for interrupting a current path. An electrically non-conductive disconnecting element can be moved therein in translation by means of an actuator unit and is configured to disconnect two contact pieces from each other, to keep them disconnected, and to function as an insulator between corresponding contact surfaces.

DE 10 2016 107 980 A1 describes, as a further approach, a bistable electromagnetic actuator device with an armature unit which can be moved between a first and a second stable position which are in each case unenergized, as a reaction to energization of stationary coil means with a supply voltage signal. Associated there with the coil means are failure control means which are designed to generate a failure energization signal, in particular in the form of a pulse, for moving the armature unit into a predetermined one of the positions.

DE 10 2023 208 606 A1 describes a protective switch with a busbar to which a fixed contact is attached, a contact bridge mounted movably with respect thereto and to which a movable contact is attached, an electric drive by means of which the contact bridge is driven, a yoke placed around the busbar, and a movably mounted slide to which an armature is attached. When a first threshold value is exceeded by an electric current conducted via the busbar, the slide is moved owing to magnetic interaction between the armature and the yoke such that a switching element connected electrically in series with the electric drive is actuated by means of the slide. Such a protective switch is intended to afford a high degree of operational safety.

In spite of these and further approaches, there is, however, also a need and scope for improvements and optimizations.

The object of the present invention is to enable efficient and safe switching of an electrical high-voltage connection.

This object is achieved by the subject matter of the main claim and the accessory claims or the independent claims. Further possible embodiments of the invention are disclosed in the dependent claims, the description, and the figures. Features, advantages, and possible embodiments that are presented as part of the description for one part of the subject matter of the independent claims should be considered, at least analogously, to be features, advantages and possible embodiments of the respective subject matter of the other independent claims and of every possible combination of the subject matter of the independent claims, optionally in conjunction with one or more of the dependent claims.

The bistable relay according to the invention can be used to switchably mechanically make, i.e., close, and mechanically break, i.e., open, an electrical connection or an electrical contact. As a central element, the relay has a lever or a lever element which is mounted on a pivot rotatably about a lever axle. The pivot is here situated in a central region of the lever element between a first end and a second end of the lever element. Also in the central region but in particular spaced apart from the pivot, the lever element has a projection protruding in the axial direction of the lever axle. This projection, i.e. for example a pin or peg or stud or cam or the like, thus projects laterally from a main part or main body of the lever element. The projection can, for example, extend lengthwise parallel to the lever axle. The first end, the second end, and a starting point of the projection on the remainder of the lever element, i.e. on a main body or main part of the lever element, can be arranged in a common plane. The projection can then extend, in a direction at right angles to this plane, away from the remainder of the lever element or from the main body or main part of the lever element, i.e., protrude, at least locally, therefrom.

The relay according to the invention moreover comprises a movably mounted actuating element which can be moved from an open position into a closed position in order to make the electrical connection and from the closed position into the open position in order to break the electrical connection. The actuating element is for this purpose mechanically connected or coupled to the first end of the lever element, in particular such that a relative movement between the lever element and the actuating element is possible. The actuating element can, for example, itself be electrically conductive at least in some regions and in the closed position then form part of the electrical connection. The actuating element can also, for example, be connected mechanically to a corresponding conductor element which forms part of the electrical connection in the closed position. In the latter case, the actuating element can in particular be insulated electrically from the conductor element. It can consequently be avoided that current or voltage is also applied to other components of the relay in the closed position of the actuating element when the relay is being used properly. The actuating element itself can, in contrast, be optimized or configured for its purpose as the point of application for the lever element and to impart or transmit a respective force for making or breaking the electrical connection.

The relay according to the invention also comprises a guide element or a guide disk which is mounted so that it can rotate back and forth about a pivot axle or shaft standing parallel to the lever axle, i.e. in two opposing directions of rotation. The shaft and the guide element can be connected non-rotatably to each other or be formed as a single part or single piece. The pivot axle or shaft, i.e., its axial direction, can here be in particular be perpendicular to a main plane of extent of the guide element and in particular also to a main plane of extent of the lever element. The guide element has, on its side facing the lever element, a guide groove which runs, in particular not in a circle, about an elongated guide rib which curves partially around the shaft. The guide groove and the guide rib can in particular be spaced apart from the shaft in the radial direction. The projection of the lever element is here guided in the guide groove such that it can move in the guide groove when the guide element rotates about the shaft, i.e. in particular during switching or triggering of the relay. The movement of the projection in the guide groove is here limited, on the one hand, by the guide rib and, on the other hand, by an outer wall, situated opposite the latter and surrounding it at a distance, of the groove.

In order to rotate the guide element about the shaft, the bistable relay has a corresponding drive, in particular an electric motor. The latter can thus be coupled correspondingly mechanically to the shaft or the guide element. In particular, the shaft can be a rotor shaft of the electric motor. A particularly simple and compact structure of the relay according to the invention can thus be achieved.

Moreover, the relay according to the invention comprises a spring element or a spring, the first end of which is connected non-rotatably to the shaft and the second end of which is connected to the second end of the lever element or is fastened thereto. The spring can thus be tensioned when the guide element is rotated about the shaft by means of the electric motor and when the lever element is simultaneously fixed.

The described components of the relay according to the invention are configured according to the invention and interact according to the invention such that, after the guide element is rotated sufficiently far about the shaft in a first direction of rotation by the spring thus tensioned, i.e. by its spring force, the lever element is pulled or moved such that the projection is pulled past a first end of the guide rib when the spring is partially or completely relaxed, and as a result the actuating element is moved, via the lever element, into the closed position. After the guide element has subsequently been rotated sufficiently far about the shaft in an opposite second direction of rotation, during which the projection moves in the direction of the second end of the guide rib and the spring is tensioned again, in particular in the opposite direction, the lever element is pulled or moved such that the projection is pulled past the second end of the guide rib by the spring, i.e., by its spring force, when the spring is partially or completely relaxed again, and as a result the actuating element is moved, via the lever element, into the open position. A relative movement between the guide rib and the projection of the lever element can thus take place during the rotation of the guide element. In particular, the projection can slide or roll along the guide rib and/or along the outer wall of the guide groove at least in some regions. The spring can here act as an over-center spring by means of which, depending on the situation or switching or actuating position of the relay, the lever element and thus also the projection can be pulled in different directions.

When the projection is here moved beyond the respective end of the guide rib, it can be suddenly moved or accelerated past the guide rib by the spring force or spring action of the spring in the direction of the opposite outer wall of the guide groove. The actuating element is also moved correspondingly suddenly or abruptly by the correspondingly sudden movement of the lever element. The relay can thus function as a snap-action switch. Particularly quick making or breaking of the electrical connection, i.e., a particularly short switching speed or a particularly high reaction speed of the relay according to the invention, can be achieved as a result. This can in turn, in particular when the relay is used to switch relatively high voltages and/or currents, improve the safety and reduce wear or erosion at electrical contact points and/or surrounding components, for example caused by arcs or sparks. The projection can be positioned correspondingly flexibly and precisely inside the guide groove by virtue of the elongated guide rib and the correspondingly elongated, for example kidney-shaped, guide groove and the precise controllability of the electric motor. As a result, the switching or triggering behavior of the relay according to the invention can be optimized, i.e., adapted to respective requirements on a case-by-case basis. Thus, for example, depending on the setting or parameterization or control, the time between a first control or switching pulse or signal to the relay and the actual making or opening of the electrical connection can be minimized and/or, for example, the robustness of the relay with respect to false triggerings, for example, due to shocks or vibrations or the like, can be increased. Because an actual switching movement is enabled by the lever element, the actuating element can, for example, move in addition to the remaining parts or components of the relay according to the invention, i.e., in addition to the guide element and the electric motor. This can overall enable a particularly compact structure, i.e., a particularly low space requirement of the relay according to the invention.

In one possible embodiment of the present invention, the first end of the spring is fastened to the shaft, in particular directly. As a result, in the case of a particularly compact structure of the relay, a particularly great length of the spring or a particularly high spring force can nevertheless be achieved. This can in turn contribute to a particularly short switching time of the relay.

In a further possible embodiment of the present invention, the spring is a spiral spring, i.e. is configured as a spiral spring, which is wound around the shaft. Depending on the direction of rotation of the shaft, the spiral spring can be tensioned in a first direction, the turns of the spiral spring being able to contract, or are tensioned in a second direction, the turns of the spiral spring being able to expand. Correspondingly, spring forces acting in different directions can then be built up. By virtue of the use of the spiral spring proposed here, spring force can be built up particularly simply and directly by rotation by means of the electric motor. In addition, a particularly compact structure of the relay is possible by virtue of the use of the spiral spring, in particular for a predetermined spring force.

In a further possible embodiment of the present invention, the relay is configured to rotate the guide element, in each case after a switching procedure, i.e. in each case after the electrical connection is made and in each case after the electrical connection is broken, by means of the electric motor so far in the opposite direction that or until the projection is situated at or directly in front of or next to that end of the guide rib past which the projection is pulled in the case of the in each case next, i.e. opposite switching procedure of the relay. The projection can then thus be situated directly at or next to the respective end of the guide rib or in a corresponding end region but at least at the corresponding half of the guide rib. For example, in order to make the electrical connection, the guide element can be rotated in a first direction of rotation until the projection has moved past a first end of the guide rib. The guide element can then be moved in an opposite direction of rotation until the projection is situated next to or at the second end of the guide rib but has not yet been pulled past said end. The electric motor can then be stopped until a next switching procedure which is then necessarily breaking of the electrical connection.

In principle, the described rotation of the guide element in the opposite direction after a switching procedure could also be performed only at the beginning of the in each case subsequent switching procedure. Because this rotation is performed, as proposed here, in the opposite direction directly following a switching procedure, the reaction time of the relay can, however, be reduced for the in each case next switching procedure because only a slight further rotation of the guide element is then necessary so that the projection is moved past the corresponding end of the guide rib and the corresponding switching procedure is thus triggered or performed.

A remaining gap, although relatively small, from the corresponding end of the guide rib can, however, optionally be useful to increase or ensure the robustness against unintended switching or triggering of the relay, for example, due to shocks or vibrations. When the guide element is, as proposed here, additionally rotated again or further in the respective opposite direction after a specific switching procedure, the spring is also already pretensioned for the in each case next switching procedure. The energy required for this next switching procedure can thus also be reduced. This can be useful, for example, for safety or emergency switching of the relay after failure of a primary energy or voltage supply. This is explained in detail elsewhere.

In a further possible embodiment of the present invention, the actuating element is moved linearly or in translation when the electrical connection is made and broken, i.e. in the case of a switching procedure of the relay. In other words, in a switching procedure a rotational movement of the lever element can thus be converted by the mechanical attachment or coupling of the lever element to the actuating element into a purely translational, i.e. non-rotational movement of the actuating element. For this purpose, the relay can, for example, also have a corresponding guide for the actuating element. By virtue of the linear or translational movement, the wear which could occur or be promoted, for example, by arcs traveling along a conductor element moved in rotation, may be avoided or reduced.

In a further possible embodiment of the present invention, the relay has an electrical energy storage unit, the capacity or energy content of which is sufficient at least for making or breaking the electrical connection once. Sufficient energy can thus be stored in this energy storage unit to perform at least one switching procedure of the relay, for example, to activate or operate the electric motor for rotation which is sufficiently far. At least one further switching procedure can thus also be performed in the event of failure of a primary or regular energy or voltage supply of the relay. In such a case, a predetermined switching state or a predetermined position of the relay can thus be set, for example, safely and reliably. Depending on the use case, this can, for example, be beneficial for the touch safety or the functional safety or the like.

In one possible development of the present invention, the relay is configured to automatically break the electrical connection by means of the energy stored in the energy storage unit in the event of failure of an operating voltage supply, i.e. of a primary or regular electrical energy or voltage or current supply of the relay. In other words, the electric motor can then thus be correspondingly supplied or operated by means of the energy stored in the energy storage unit in order to rotate the guide element into a corresponding rotated position and consequently to bring the actuating element into the open position. Additionally, the relay can here comprise a corresponding microelectronic system or circuit or logic system in order to cause, for example, the triggering or the switching of the relay in the event of or after failure of the operating voltage supply or also to monitor the operating voltage supply. Depending on the use case or as needed, it can thus be specified, i.e., predetermined, more accurately, for example by a corresponding predetermined triggering condition or fault condition, when the energy stored in the energy storage unit is used to switch the relay, in particular to break the electrical connection. It can, for example, be predetermined as a result that this already takes place when the regular operating voltage supply falls below a predetermined threshold value and/or only when the regular operating voltage supply has fallen for at least a predetermined period of time.

In order to achieve corresponding safe breaking of the electrical connection, monostable relays can conventionally be used in the case of a fault which, however, have a higher energy requirement during regular operation than bistable relays. If, in order to avoid a permanent higher energy requirement, a conventional bistable relay is used, additional complex measures must where appropriate be taken in order to ensure a corresponding level of functional safety of the regular or primary energy or operating voltage supply. This additional complexity and the costs associated therewith can be reduced at least partly by the development of the present invention proposed here.

According to one possible development of the present invention, the energy storage unit is or comprises a capacitor. With such a capacitor, the energy stored therein can be provided particularly quickly for switching the relay. In addition, a capacitor can, for example, have a particularly low self-discharge compared with a battery. As a result, it can be ensured correspondingly over a long term and reliably that the relay can be brought into the predetermined switching state in the event of failure of the regular energy or operating voltage supply.

A battery could also be used in addition or as an alternative to the energy storage unit. More energy could thus be stored where appropriate such that multiple switching procedures of the relay could be performed in the event of failure of the operating voltage supply.

The present invention also relates to a motor vehicle which is equipped with at least one bistable relay according to the invention.

In one possible development of the present invention, the motor vehicle has a high-voltage store, i.e. a traction battery, and at least one electrical consumer connected thereto for supplying electricity. The bistable relay according to the invention is then arranged to switchably disconnect and close an electrical conductive path or current path via which the at least one electrical consumer can be supplied from the traction battery. The relay can thus be integrated into this conductive or current path. This conductive or current path can thus be the electrical connection mentioned in connection with the relay according to the invention. The relay can be arranged, for example, between the traction battery and the at least one electrical consumer or be integrated into the traction battery. By switching the relay, for example a high-voltage supply for a drive of the motor vehicle or a high-energy supply of the motor vehicle or the like can thus be switched, i.e. established and disconnected.

Further features of the invention can be found in the claims, the figures, and the description of the figures. The features and feature combinations mentioned above in the description, and the features and feature combinations below in the description of the figures and/or shown in the figures alone, can be used not only in the respective specified combination but also in other combinations or individually, without departing the scope of the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a partial schematic perspective illustration of a bistable relay;

FIG. 2 shows a partial schematic perspective illustration in which further components have been suppressed for illustrative purposes;

FIG. 3 shows a partial schematic side view of the relay immediately after closing;

FIG. 4 shows a partial schematic side view of the relay at the end of a switching procedure for closing the relay;

FIG. 5 shows a partial schematic side view of the relay immediately after opening; and

FIG. 6 shows a partial schematic illustration of a motor vehicle having the relay.

### DETAILED DESCRIPTION OF THE DRAWINGS

In the figures, identical and functionally identical elements are denoted by the same reference signs.

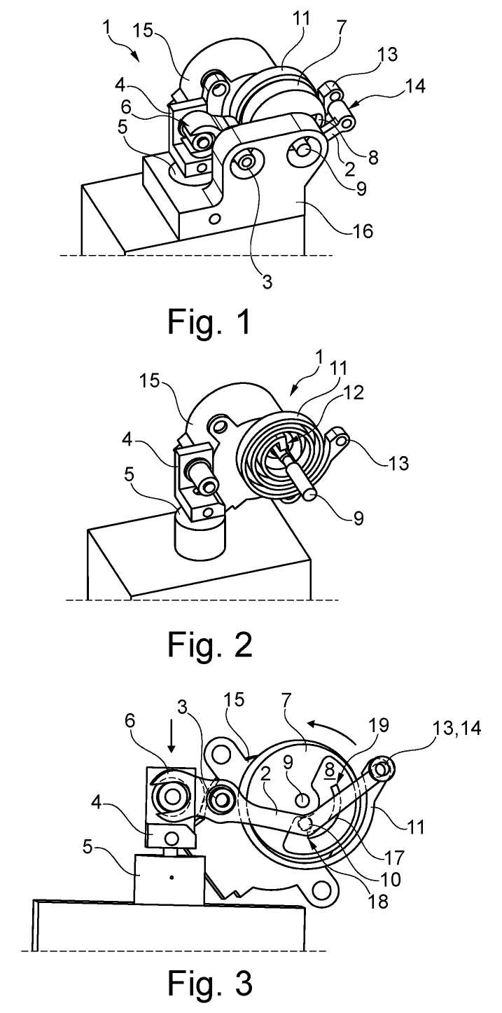

FIG. 1 shows a partial schematic perspective illustration of a mechanical or electromechanical bistable relay 1. The relay 1 comprises a lever 2 which is mounted rotatably about a lever axle 3. By virtue of movement of the lever 2, an actuating element 4 can be moved, which is in turn fastened to and correspondingly moved with or relative to a contact element 5 that is correspondingly also moved. An electrical connection can thus ultimately be made or broken. In order to transmit the corresponding movement of the lever 2 to the actuating element 4, a first lever end 6 of the lever 2 is here coupled to the actuating element 4. A rotational movement of the lever 2 about the lever axle 3 can thus be converted into a linear translational movement of the actuating element 4. To do this, the lever 2 here engages with a first lever end 6 about an axis of the actuating element 4.

In order in turn to control or to determine the movement of the lever 2, the relay 1 here also has a guide element 7 which is substantially shaped like a disk or a flattened cylinder. The latter is situated on a side, remote from the actuating element 4, of the lever axle 3 next to the lever 2. On its side facing the lever 2, the guide element 7 has a guide groove 8 open toward the lever 2. In addition, the guide element 7 is mounted rotatably about a shaft 9 which runs parallel to the lever axle 3. The lever 2 in turn has a projection or pin 10 on its side facing the guide element 7 (see FIGS. 3 to 5). This pin 10 engages in the guide groove 8 and is guided therein. The pin 10 can thus only move in the guide groove 8 such that as a result the possible and actual movement of the lever 2 is restricted.

In order to assist the movement of the lever 2 or accelerate it during switching of the relay 1, the relay 1 also has a spiral spring 11. The spiral spring 11 is fastened directly or indirectly at the shaft 9 with its inner spring end 12 (see FIG. 2), whilst an outer spring end 13 of the spiral spring 11 is fastened at a second lever end 14 of the lever 2. In order now to effect corresponding movements of the components in order to switch the relay 1, the relay 1 also has an electric motor 15. This electric motor 15 can rotate or drive the shaft 9. Via the shaft 9, the guide element 7 connected non-rotatably thereto is here also rotated about the shaft 9. In addition, the spiral spring 11 can thus be tensioned. The relay 1 also comprises a bracket 16 as an abutment or for fastening or holding the different components of the relay 1. The bracket 16 can provide, for example, fastening points and/or bearing points, for example, for the lever axle 3, the shaft 9, or also the electric motor 15, and/or serve as a housing and/or for fastening the relay 1 at other components.

In order to further illustrate the structure of the relay 1, FIG. 2 shows a partial schematic perspective illustration of the relay 1 in which different components, in particular the lever 2, the guide element 7, and the bracket 16, have been suppressed. Accordingly, the spiral spring 11, which is wound around the shaft 9, can be seen here. In addition, the inner spring end 12 and its arrangement or fastening on the shaft 9 can be seen here.

FIG. 3 shows, in order to illustrate the functioning of the relay 1, a partial schematic side view of the relay 1 in a state or a position immediately after making the electrical connection, i.e., after a movement of the actuating element 4 from an open position into a closed position. This movement, already completed here, of the actuating element 4 is indicated by a vertical straight arrow. Immediately preceding the state shown here was a counterclockwise rotation of the guide element 7, indicated by a corresponding curved arrow. By virtue of this rotation of the guide element 7 by means of the electric motor 15, the lever 2 could, because of the spring force, engaging at the second lever end 14, of the spiral spring 11 also move counterclockwise about the lever axle 3 and consequently press the actuating element 4 downward into the closed position.

During this movement of the lever 2, the pin 10 moves inside the guide groove 8. A guide rib 17 is situated centrally inside the guide groove 8. In other words, the guide groove 8 runs around the guide rib 17. The guide rib 17 is elongated and partially curved around the shaft 9 with a certain radial gap therefrom. Immediately before the counterclockwise rotation of the guide element 7, the pin 10 was situated radially outside the guide rib 17 in the guide groove 8, i.e., in a radially outer region of the guide groove 8, and was thus prevented by the guide rib 17 from moving, i.e., yielding to or following the spring force of the spiral spring 11. By virtue of the rotation of the guide element 7, the guide rib 17 was, however, moved so far relative to the pin 10 that the latter could be pulled by the spring force of the spiral spring 11 past a first guide rib end 18 of the guide rib 17 into a radially inner region of the guide groove 8 or onto a radially inner side of the guide rib 17. The result of this movement, running at least partially or at least largely in a radial direction with reference to the shaft 9, of the pin 10 is that the rotation of the lever 2 about the lever axle 3 is effected.

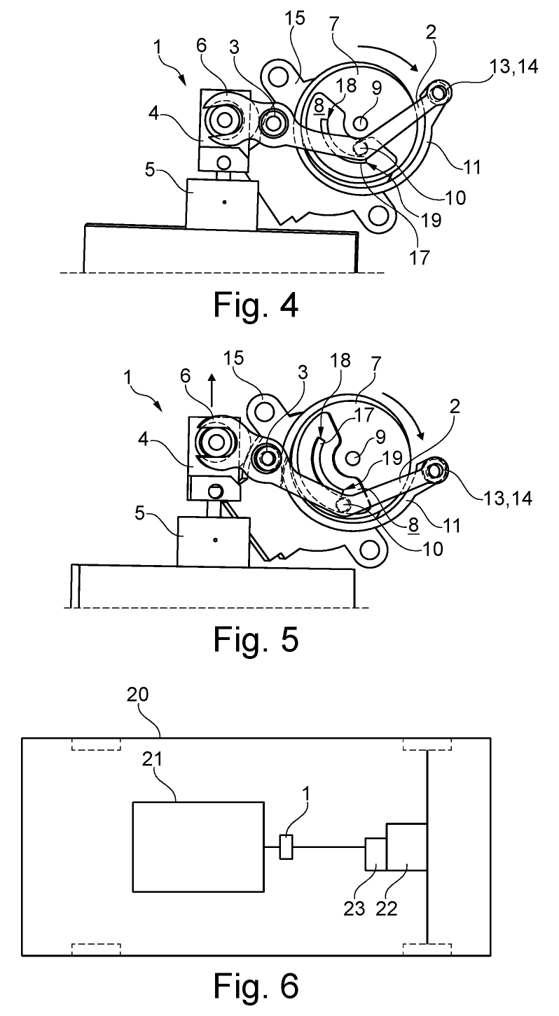

Following the state illustrated in FIG. 3, the guide element 7 can be rotated by means of the electric motor 15 in the opposite direction, i.e., clockwise, until the pin 10, still radially on the inside of the guide rib 17 or in a radially inner region of the guide groove 8, is situated at or next to a second guide rib end 19 of the guide rib 17. FIG. 4 shows a partial schematic side view of the relay 1 in this state. During the rotation, which has taken place between the state illustrated in FIG. 3 and the state illustrated in FIG. 4, of the guide element 7, the pin 10 has moved in the radially inner region or part of the guide groove 8 along the guide rib 17 from its first guide rib end 18 as far as its second guide rib end 19. This is, however, in particular to be understood only as relative movement between the pin 10 and the guide element 7 or the guide groove 8 and here takes place at least primarily or exclusively by the rotation of the guide element 7. The lever 2 can in the meantime thus remain at least substantially in a fixed position, for example, relative to the bracket 16 or the surroundings. Accordingly, the actuating element 4 also remains in its position or situation already shown in FIG. 3 such that the switching state of the relay 1 does not change.

In order now to trigger or perform the next switching procedure of the relay 1, i.e., to move the actuating element 4 into its open position and thus to break the electrical connection, the guide element 7 can be rotated somewhat further clockwise by means of the electric motor 15. This further clockwise rotation of the guide element 7 can be smaller or shorter than the preceding clockwise movement of the guide element 7, by means of which the pin 10 has been moved from the region of the first guide rib end 18 into the region of the second guide rib end 19. Because of the further rotation of the guide element 7, the spring force of the spiral spring 11 can then pull the pin 10 radially outward past the second guide rib end 19. This means clockwise rotation of the lever 2 about the lever axle 3. As a result, the actuating element 4 is moved linearly or in translation upward into the open position, indicated here by a corresponding straight arrow.

Immediately afterward, the guide element 7 can be rotated by means of the electric motor 15, for example, in the opposite direction again to the switching procedure which has just been performed, i.e., here counterclockwise, until the pin 10 is situated in the radially outer region of the guide groove 8 next to the first guide rib end 18. From there, the state illustrated in FIG. 3 can then be reproduced by a slight further counterclockwise rotation of the guide element 7, i.e., the actuating element 4 can be moved into its closed position and thus the electrical connection can be made again.

In order to operate the electric motor 15 in order to effect the described rotational movements of the guide element 7, the electric motor 15 can be connected to a corresponding electrical external energy or voltage supply. Likewise, the relay 1 can have an energy storage unit, for example a capacitor or a battery, from which the electric motor 15 can be supplied with energy at least for one switching procedure.

The relay 1 can be used, for example, in the automotive sector. In addition, FIG. 6 shows a partial schematic illustration of a motor vehicle 20. The motor vehicle 20 is here an electrified vehicle and accordingly has a traction battery 21 and an electric drive. The electric drive is here represented schematically by a traction machine 22 and a power electronics system 23. The power electronics system 23 can comprise, for example, a voltage transformer for transforming a voltage supplied by the traction battery 21 into an operating voltage for the traction machine 22. The relay 1 is here integrated schematically into an electrical connection between the traction battery 21 and the electric drive. The supply of electricity to the drive from the traction battery 21 can thus be interrupted and restored by means of the relay 1. In particular, the relay 1 can be integrated into a low-voltage electrical system of the motor vehicle 20 for regular, i.e., fault-free operation. If this low-voltage electrical system, i.e. the external energy or operating voltage supply of the relay 1, fails, the relay 1, supplied by the local energy storage unit, can automatically break the electrical connection, i.e., move the actuating element 4 into the open position.

Taken together, the described examples show how a bistable relay 1 can be implemented and used as a snap-action switch and where appropriate with automatic switch-off independently of an external energy or voltage supply.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 relay
2 lever
3 lever axle
4 actuating element
5 contact element
6 first lever end
7 guide element
8 guide groove
9 shaft
10 pin
11 spiral spring
12 inner spring end
13 outer spring end
14 second lever end
15 electric motor
16 bracket
17 guide rib
18 first guide rib end
19 second guide rib end
20 motor vehicle
21 traction battery
22 traction machine
23 power electronics system

What is claimed is:

1. A bistable relay for switchably making and breaking an electrical connection, the bistable relay comprising:
a lever element mounted rotatably about a lever axle on a pivot in a central region
between a first end and a second end of the lever element, the lever element including in the
central region a projection protruding in the axial direction of the lever axle;
a movably mounted actuating element configured to be movable from an open
position into a closed position in order to make the electrical connection and from the closed
position into the open position in order to break the electrical connection, the movably
mounted actuating element being coupled mechanically to the first end of the lever element;
a guide element mounted rotatably about a shaft standing parallel to the lever axle and
including, on a side facing the lever element, a guide groove which runs about an elongated
guide rib which curves partially around the shaft and in which the projection is guided such
that the guide rib is movable in the guide groove when the guide element rotates about the
shaft;
an electric motor configured to rotate the guide element about the shaft;
a spring including a first end connected non-rotatably to the shaft and a second end
connected to the second end of the lever element;
wherein the bistable relay is configured such that after the guide element is rotated in
a first direction of rotation by the spring thus tensioned, the projection is pulled past a first
end of the guide rib when the spring is relaxed, and as a result the actuating element is
moved, via the lever element, into the closed position and, after subsequent rotation of the
guide element in an opposite second direction of rotation, during which the projection moves
in the direction of the second end of the guide rib and the spring is tensioned again, the
projection is pulled past the second end of the guide rib by the spring when the spring is
relaxed, and as a result the actuating element is moved, via the lever element, into the open position.

2. The bistable relay according to claim 1, wherein the first end of the spring is fastened on the shaft.

3. The bistable relay according to claim 1, wherein the spring is a spiral spring which is wound around the shaft.

4. The bistable relay according to claim 1, wherein the bistable relay is configured in each case after a switching procedure to rotate the guide element by the electric motor in an opposite direction until the projection is situated at the end of the guide rib past which the projection is pulled in each next switching procedure.

5. The bistable relay according to claim 1, wherein the actuating element is moved only in translation when the electrical connection is made and broken.

6. The bistable relay according to claim 1, further comprising an electrical energy storage unit, a capacity of which is sufficient at least for making or breaking the electrical connection once.

7. The bistable relay according to claim 6, wherein the bistable relay is configured to automatically break the electrical connection by the energy stored in the electrical energy storage unit in an event of failure of an operating voltage supply of the bistable relay.

8. The bistable relay according to claim 6, wherein the electrical energy storage unit comprises a capacitor.

9. The bistable relay according to claim 7, wherein the electrical energy storage unit comprises a capacitor.

10. A motor vehicle having a bistable relay according to claim 1.

11. The motor vehicle according to claim 10, wherein the motor vehicle has a traction battery and at least one electrical consumer connected thereto for supplying electricity, and the bistable relay is arranged to switchably disconnect and close an electrical current path via which the at least one electrical consumer can be supplied from the traction battery.
